(19) United States
(12) Patent Application Publication
(10) Pub. No.: US 2010/0046690 A1
(43) Pub. Date: Feb. 25, 2010

(54) Apparatus and Method for Detection of Fissile Material Using Active Interrogation

(75) Inventors: Alan Proctor, Knoxville, TN (US); Tony A. Gabriel, Knoxville, TN (US)

Correspondence Address: LUEDEKA, NEELY & GRAHAM, P.C., P O BOX 1871, KNOXVILLE, TN, 37901, US

(73) Assignee: NUCSAFE, INC., Oak Ridge, TN (US)

(21) Appl. No.: 12/196,462

(22) Filed: Aug. 22, 2008

(51) Int. Cl. G01T 3/02; G01T 7/00; G01T 1/00; G01T 3/00

(52) U.S. Cl. 376/154; 250/390.01

(57) ABSTRACT

A system for interrogating a package, container, vehicle, or similar examination article for the presence of nuclear material. The system typically includes a source of photo-fission energy configured to irradiate the examination article and trigger fission of a fissile or a fissionable material present in the examination article and generate a plurality of fission products, wherein at least one of the plurality of fission products produces a plurality of fission neutrons. A neutron-to-gamma-ray-converter material may be configured to capture up to all of the plurality of fission neutrons and upon capture to emit internal gamma radiation. A gamma radiation detector is typically configured to detect at least a portion of the internal gamma radiation.

### GOVERNMENT RIGHTS

The U.S. Government has rights to this invention pursuant to Contract HDTRA1-05-D-0004 between the Defense Threat Reduction Agency of the U.S. Department of Defense and Nucsafe, Inc.

### FIELD

This disclosure relates to the field of detection of nuclear material. More particularly, this disclosure relates to the detection of fissile material in a package, container or vehicle.

### BACKGROUND

Various consumer, industrial, military and government activities involve a risk that nuclear material that may be inappropriately stored or transported in packages, containers or vehicles. The prospect of nuclear terrorism heightens concerns regarding these risks. Various systems have been developed to detect such nuclear materials, but uncertainty regarding the nature of the nuclear material and its packaging environment often adversely affects its detection. What are needed therefore are improved systems for detecting nuclear materials in packages, containers or vehicles.

### SUMMARY

The present disclosure provides a radiation detection system having a gamma radiation detector and a neutron-to-gamma-ray-converter material surrounding at least a portion of the gamma radiation detector. There is typically a lead shield surrounding a substantial portion of the neutron-to-gamma-ray-converter material and surrounding at least a portion of the gamma radiation detector.

Another embodiment provides a system for interrogating an examination article for the presence of a fissionable material. The system includes a photo-fission energy beam configured to irradiate the examination article and trigger fission of the fissionable material, wherein delayed fission neutrons are generated. The system of this embodiment also includes a detector system that has (a) a neutron-to-gamma-ray-converter material configured to capture up to all of the plurality of delayed fission neutrons and upon capture to emit delayed internal gamma radiation, and (b) a gamma radiation detector configured to detect at least a portion of the delayed internal gamma radiation.

Also provided is a method of detecting the presence of a fissionable material in an examination article. In one embodiment the method includes a step of irradiating the examination article with energy sufficient to induce fission of at least a portion of the fissionable material present in the examination article, wherein external delayed gamma radiation and delayed fission neutrons are produced. The method typically further includes a step of capturing in a neutron-to-gamma-ray-converter material at least a portion of the delayed fission neutrons wherein delayed internal gamma radiation is generated. Further steps of this embodiment include compiling a first delayed gamma radiation count in a first energy range over a time window, and compiling a second delayed gamma radiation count in a second energy range over the time window. The method of this embodiment typically concludes with evaluating whether a combination of the first gamma radiation count and the second gamma radiation count represents a signature that is indicative of the presence of fissionable material in the examination article.

In some embodiments the gamma radiation detector is further configured to detect at least a portion of external gamma radiation that is emitted by a neutron capturing material that is disposed proximal to the fission products and that captures up to all of the plurality of fission neutrons and upon capture emits the external gamma radiation. In some embodiments the neutron-to-gamma-ray converter includes a borated polymer such as borated polyethylene or some other material which gives distinctive gamma-rays. Some embodiments provide a radiation analysis system that is configured to evaluate whether a count of the internal and/or the external gamma radiation attributable substantially to a capture of a plurality of delayed fission neutrons and delayed gamma radiation exceeds a threshold that is at least in part indicative of the presence of fissile or fissionable material in the examination article. For example, a threshold may be set for the ratio of the number of high energy gamma-rays to the number of low energy gamma-rays separated at some energy level such as 2 MeV.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1a is a diagram depicting interactions produced by an accelerator beam interacting with fissionable material.

FIG. 1b is a diagram depicting interactions produced by an accelerator beam interacting with inert material having fission threshold energy(ies) below the accelerator beam energy.

FIG. 1c is a diagram depicting interactions produced by an accelerator beam interacting with inert material having fission threshold energy(ies) above the accelerator beam energy.

FIG. 2 is a somewhat schematic view of a detection system for nuclear material.

FIG. 3 is a somewhat schematic view of the cross section of a radiation detection system.

FIG. 4 is a somewhat schematic view of the cross section of an alternate configuration of a radiation detection system.

FIG. 5 is a somewhat schematic perspective view of a radiation detection system of the type depicted in FIG. 2.

FIG. 6 is a timing plot for photofission events.

FIG. 7 is a plot of detected gamma radiation predicted by a computer model applied to a detection system of the type depicted in FIG. 1.

FIG. 8 presents bar graphs of calculated photofission delayed gamma signature ratios for various test materials in various packaging matrices.

FIG. 9 presents bar graphs of photofission neutron capture gamma radiation counts for various test materials in various packaging matrices.

### DETAILED DESCRIPTION

In the following detailed description of the preferred embodiments, reference is made to the accompanying drawings, which form a part hereof, and within which are shown by way of illustration the practice of specific embodiments of a system for interrogating an examination article for the presence of fissile or fissionable material, and embodiments of a method of detecting the presence of fissile or fissionable material in an examination article. It is to be understood that other embodiments may be utilized, and that structural changes may be made and processes may vary in other embodiments.

The detection of fissile material is of particular interest in investigating packages, containers or vehicles for the presence of nuclear material. As used herein the term “fissile material” is defined as any material fissionable by thermal (slow) neutrons. The three primary fissile materials are uranium-233 (²³³U), uranium-235 (²³⁵U) and plutonium-239 (²³⁹Pu). U-238 (²³⁸U) is fissionable by more energetic particles. The term “fissionable” refers to materials in which fission may be induced by energies of about 20 MeV or less. Hence uranium-233 (²³³U), uranium-235 (²³⁵U), plutonium-239 (²³⁹Pu), and U-238 (²³⁸U) are “fissionable.” Materials that are not fissionable at energies of about 20 MeV or less are referred to herein as “inert.” Many materials including lead and iron may undergo fission but at only at higher energies, and therefore are considered to be inert for purposes intended herein.

The detection of fissile or fissionable material in a package, container, or vehicle may involve exposing the package, container, or vehicle to radiation of sufficient energy to induce fission of the material. The fission process results in various forms of induced radiation that may be measured in order to detect the presence of the fissile material. This induced radiation varies significantly in nature depending on the particular nuclear materials that are present, thus often making the detection of fissile material quite difficult. A further difficulty in detecting fissile material is that the fissile material may be packaged in material that either absorbs portions of the induced radiation or alters its nature. For example, if the fissile material is disposed within a package that includes hydrogen-bearing neutron-capturing material (such as water, wood, or oil), at least a portion of the fission neutrons will be captured and will emit a gamma ray at an energy level of approximately 2.2 MeV. On the other hand, if the fissile material is disposed in a neutron transparent environment, substantially all of the fission neutrons will escape the environment. The most likely situation is that some of the fission neutrons will be captured by neutron capturing material disposed around the fissile material and some of the fission neutrons will escape.

“Photofission,” as the term is used herein, refers to an active interrogation technique in which high energy (5-20 MeV) gamma radiation is used to induce fission in “fissionable” (i.e. ²³³U, ²³⁵U, ²³¹U, ²³⁹Pu) materials. Materials respond to this interrogating radiation by producing various fission products that emit additional gamma radiation and neutrons. In addition, while many elements fission when bombarded with high energy photon radiation, only ‘fissionable’ materials generate ‘delayed’ radiations and particles after being interrogated. Delayed fission time constants and emitted particles are well known for ²³³U, ²³⁵U, ²³⁸U, and ²³⁹Pu. Various detectors for these radiations and algorithms that exploit these delayed emissions for determining the presence of fissionable materials are described herein.

Preferred embodiments incorporate photofission detectors that are based on gamma spectroscopy of delayed gamma radiation and detection of delayed neutrons, making them ‘dual mode’ detectors, a highly advantageous capability. Bismuth Germanate Oxide (BGO) scintillators are typically used for delayed gamma detection. Neutrons are detected when they are captured by ¹⁰B or other neutron capture material such as ¹⁵⁶Gd, ¹⁵⁷Gd, or ¹⁶⁰Gd. Neutron capture by ¹⁰B generates an alpha particle and a characteristic 478 keV gamma ray. Neutron capture by ¹⁵⁶Gd produces characteristic 6360 keV gamma radiation; neutron capture by ¹⁵⁷Gd produces characteristic 6750 keV gamma radiation; neutron capture by ¹⁶⁰Gd produces characteristic 5320 keV gamma radiation. Gamma spectroscopy may be used to determine the energies of delayed gamma rays from fissions and from neutron capture in boron or gadolinium or other neutron capturing materials. Delayed neutrons and gammas are emitted from the initial active photon interrogation and then generated internally from the sample from fissions caused by previously generated neutrons. Since the sample is subcritical, fission decays once the photon interrogation is shut off. Data that are collected consist of spectra which are analyzed for signatures indicative of fissionable materials.

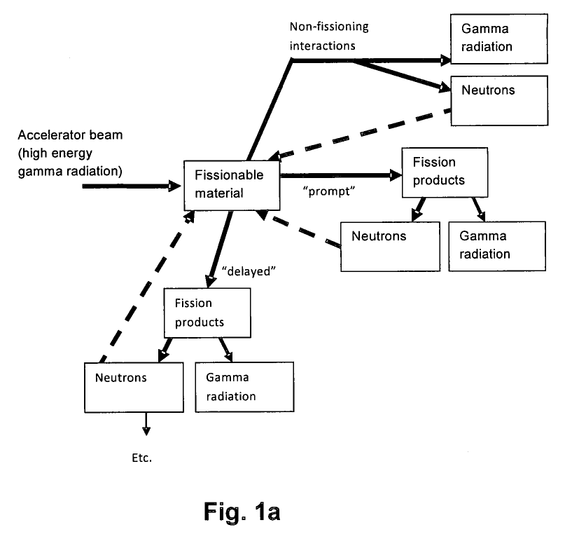

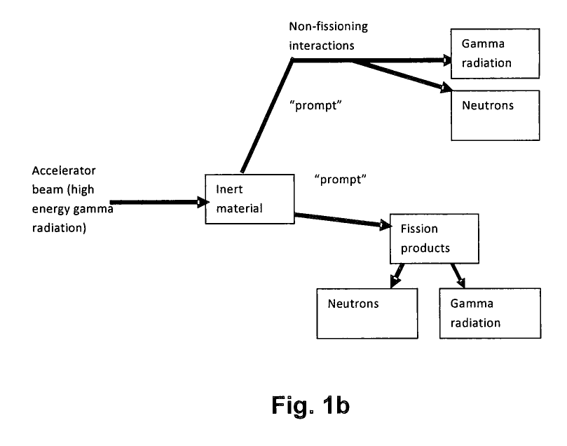

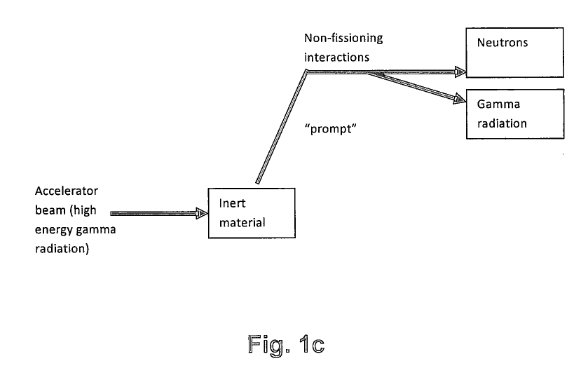

Gamma radiation produced by fission products is important as well as neutrons. For example, fission products generated by the accelerator interacting with fissionable material may produce both gamma radiation and neutrons as illustrated in FIG. 1a. In this illustration radiation from the accelerator beam generates an initial group of fission products. These products decay with several time constants—faster decays are ‘prompt’ and slower decays are ‘delayed’. Gamma radiation from the accelerator generated fission is part of the gamma radiation measurements. The same fission products also produce neutrons (prompt and delayed) that can generate secondary fissions depending on the degree of moderation and the target material configuration. These secondary fissions produce fission products that release gamma radiation and more neutrons. The process continues until ‘all’ the free neutrons in the sample are absorbed or escape. The accelerator is pulsed; it is ‘off’ by the time the process ends so no new photofission occurs. As noted, high energy radiation produced by the accelerator can cause a variety of ‘inert’ materials to fission, but their fission products release gamma radiation and/or neutrons in short times—‘prompt’ decay. There is no secondary fission due to neutron capture. Prompt neutrons from fission and non-fission reactions may produce additional gamma radiation in the surrounding materials either by neutron capture or by excitation.

Certain accelerator beam interactions with inert material are depicted in FIGS. 1b and 1c. In FIG. 1b the accelerator beam is interacting with inert material having fission threshold energy(ies) below the accelerator beam energy. In this circumstance prompt interactions occur that include non-fissioning interactions and the production of fission products, but no delayed interactions occur. In FIG. 1c the accelerator beam is interacting with inert material having fission threshold energy(ies) above the accelerator beam energy. In this circumstance prompt non-fissioning interactions occur but no fission products are produced and no delayed interactions occur.

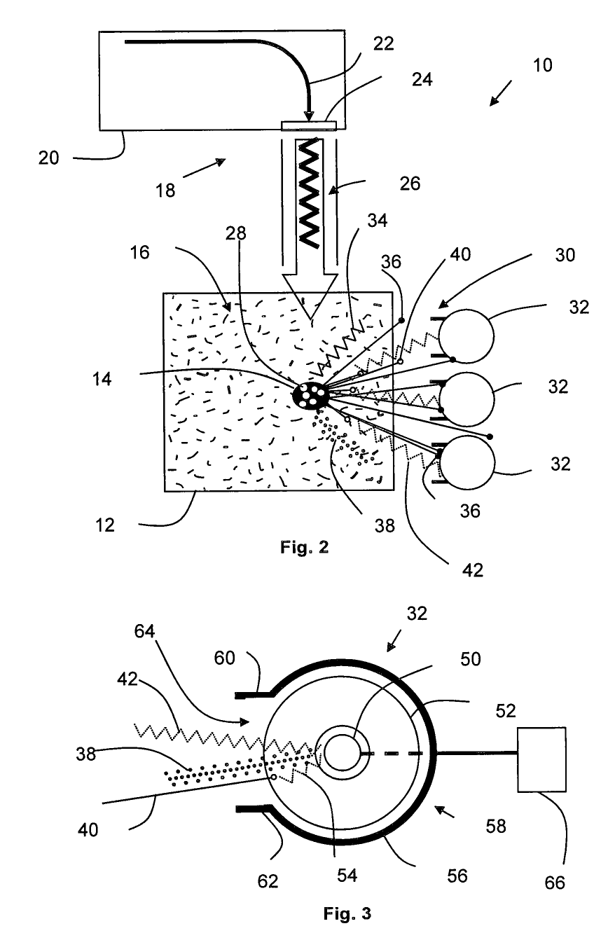

One embodiment of a system 10 for interrogating an examination article for the presence of nuclear material, and fissile material in particular, is illustrated in FIG. 2 where an examination article 12 is being inspected. The examination article 12 may be a package, a shipping container, a barrel, a vehicle, or any article that might be suspected of containing fissile material. In the embodiment depicted in FIG. 2, the examination article 12 contains fissile material 14. The fissile material 14 is disposed proximal to a packing material 16. The packing material 16 may include (a) only material that is substantially transparent to neutrons (such as air), or (b) material such as wood, water, or oil that captures neutrons, or (c) a combination of (a) and (b) or other materials or combinations of these materials that are partially transparent to neutrons or that may capture portions of but not all emitted neutrons.

To inspect the contents of examination article 12 the embodiment of FIG. 2 uses a gamma radiation generator 18 to interrogate the examination article 12. The gamma radiation generator 18 includes a linear accelerator 20 that directs an electron beam 22 to impact a thin (for example 2.2 mm thick) tungsten target 24 with pulses of 15 MeV±5 MeV electrons. The duration of each pulse is typically fifty nanoseconds and the pulse rate is typically fifteen Hz. However the duration of each pulse may range between approximately ten and approximately one hundred nanoseconds and the pulse rate may range between approximately ten Hz and approximately twenty Hz. In some embodiments the pulse durations and/or the pulse frequency may be beyond those ranges. The charge output per pulse is typically between about seventy and one hundred twenty nCoulombs per pulse. Each nominally 15 MeV pulse produces a gamma radiation beam 26 of up to 15 MeV that is directed into the examination article 12. Such gamma radiation beams are referred to as photo-fission energy beams. It is important to note that the magnitudes of the various pulse parameters described herein are typical values used in one embodiment and other embodiments may employ different parametric magnitudes.

When the gamma radiation beam 26 strikes the fissile material 14 at least a portion of the fissile material undergoes fission, generating a plurality of fission products 28 and bursts of radiation 30. The bursts of radiation 30 are directed in 360 spherical degrees, but for simplicity of illustration in FIG. 2 only a portion of the bursts of radiation 30 that are directed in the general direction of three radiation detector systems 32 are depicted. In different embodiments less than three or more than three radiation detector systems may be utilized. The radiation bursts 30 include prompt gamma radiation 34 that accompanies the fission process without any significant time delay. The radiation bursts 30 also include prompt fission neutrons 36 that are emitted without any significant time delay when the fission occurs but arrive later at the detectors since they travel slower than light speed and also can bounce around the room many times generating gamma-rays as they interact with the nuclei in the walls and other materials present. In addition, the bursts of radiation 30 include fission-generated delayed gamma radiation 38 and delayed fission neutrons 40 that are emitted by one of the fission products 28 after a delay typically ranging from a few milliseconds to up to approximately a hundred seconds after the fission occurs.

If the packing material 16 includes neutron capturing material, some of the delayed fission neutrons 40 may be captured by the neutron capturing material, or if the neutrons are energetic enough they may excite the nucleus which may then decay by gamma-ray emission without the capture of a neutron. Upon capturing a neutron the neutron capturing material emits additional neutron-induced delayed gamma radiation 42 and a portion of the neutron-induced delayed gamma radiation 42 strikes one of the radiation detector systems 32. A portion of the fission-generated delayed gamma radiation 38 also strikes one of the radiation detector systems 32. The fission-generated delayed gamma radiation 38 and the neutron-induced delayed gamma radiation 42 are referred to as “external” because they are created external to the three radiation detector systems 32. Note that “delayed external gamma radiation” as defined herein does not include background gamma radiation occurring from natural sources or from any artificial sources other than (1) fission-generated delayed gamma radiation 38 and (2) neutron-induced delayed gamma radiation 42 emitted by the capture (external to the three radiation detector systems 32) of delayed fission neutrons 40 produced by fission of the fissile material 14.

In summary, fissioning material produces neutrons and gamma radiation. High energy gamma radiation (from the accelerator)+²³⁵U or ²³⁸U or ²³⁹Pu yields:

Prompt neutrons and gamma radiation

Delayed neutrons and gamma radiation.

Both prompt and delayed neutrons can produce additional gamma radiation and additional neutrons through additional fissions and non-fissioning interactions. Non-fissioning material around the target can generate gamma radiation and to a lesser extent more neutrons via various reactions caused by previously generated gamma radiation and neutrons. For high energy gamma radiation incident on non-fissioning material prime targets, only prompt neutrons and gamma radiation are produced. Additional gamma radiation is produced by neutrons reacting with these non-fissioning materials but the gamma radiation will still be in the time frame of prompt gamma, that is ˜100 nsec after the accelerator pulse.

FIG. 3 illustrates further details of the radiation detection system 32. The radiation detection system 32 includes a gamma radiation detector 50. The gamma radiation detector 50 is typically a bismuth germanate oxide (BGO) gamma ray detector. The gamma radiation detector 50 is enclosed in a neutron-to-gamma-ray-converter material 52. The neutron-to-gamma-ray-converter material 52 typically includes a neutron capturing material such as boron or gadolinium and a hydrogen containing material such as a polymer resin. When polyethylene and boron are used it is generally sufficient to provide a boron/polyethylene layer comprising about five percent by weight of natural boron dispersed in the polyethylene. Natural boron contains 15% ¹⁰B, which is used to convert incoming neutrons to gamma radiation. The polyethylene moderates the neutron energies, increasing the likelihood that they will be captured by the ¹⁰B.

Generally the neutron-to-gamma-ray-converter material 52 is configured to capture at least a portion of the plurality of delayed fission neutrons 40 but typically the neutron-to-gamma-ray-converter material 52 captures only a small fraction of the plurality of delayed fission neutrons 40. In broadest terms, the neutron-to-gamma-ray-converter material 52 may be configured to capture up to all of the plurality of delayed fission neutrons 40. As used herein, the term “up to all” includes “none.” Thus, “up to all” of the plurality of delayed fission neutrons 40 includes embodiments where none of the plurality of delayed fission neutrons 40 is captured. In a preferred embodiment the neutron-to-gamma-ray-converter material includes borated polyethylene or gadolinium-containing polyethylene. Hydrogen will enhance the thermalization of the neutrons and therefore enhance neutron capture in the borated polyethylene or gadolinium-containing polyethylene material.

If delayed fission neutrons 40 enter the gamma radiation detection system 32, at least a portion of the delayed fission neutrons 40 may be captured by the neutron-to-gamma-ray-converter material 52 and delayed “internal gamma radiation” 54 may be generated, which may strike the gamma radiation detector 50. The delayed internal gamma radiation 54 is referred to as “internal” because it is created within the radiation detection system 32. The gamma radiation detector 50 depicted in FIG. 3 is configured to detect at least a portion of the delayed internal gamma radiation 54. As previously indicated with respect to FIG. 2, external neutron-induced delayed gamma radiation 42 may be created within the examination article 12 and may enter the radiation detection system 32 where it may also be detected by the gamma radiation detector 50. The gamma radiation detector 50 is typically configured to detect at least a portion of neutron-induced delayed external gamma radiation 42 that is emitted by a neutron capturing material in the packing material 16 that captures up to all of the plurality of delayed fission neutrons 40 (and upon capture emits the neutron-induced delayed external gamma radiation 42).

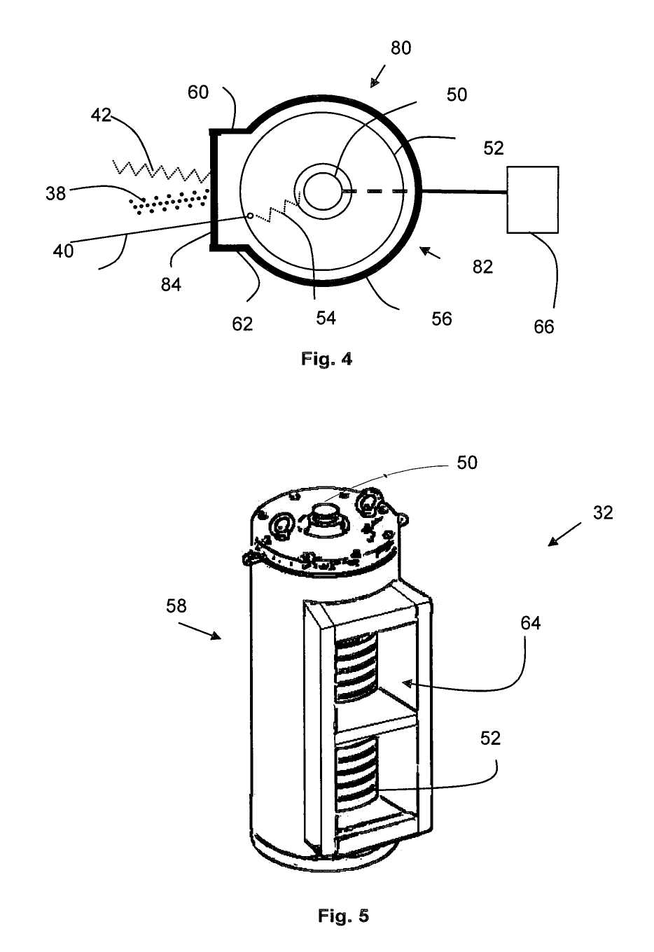

As further illustrated in FIG. 3, in many embodiments the gamma radiation detector 50 and the neutron-to-gamma-ray-converter material 52 are substantially enclosed in a lead shield 58. The lead shield 58 is typically about one inch thick, but thicknesses ranging between about 0.5 and 1.25 inches may be used. In some environments, especially where high energy gamma rays (>2 MeV) are present, it may be helpful to increase the thickness of the lead to two inches or more. The lead shield 58 includes a cylindrical section 56, and aperture panels 60 and 62. The lead shield 58 is desirable to remove uncontrollable, unknown contributions from ‘background’ radiation, especially in environments that may have a large amount of background radiation. The lead cylindrical sections 56 may be employed to reduce such interference. In an alternate configuration depicted in FIG. 4 a lead face plate 84 may be disposed between the aperture panels 60 and 62 so that the gamma radiation detector 50 and the neutron-to-gamma-ray-converter material 52 are completely surrounded by lead plate. The lead face plate 84 may be particularly beneficial in ‘passive’ scanning of samples—i.e., measuring the gamma emission from a sample prior to interrogation. The passive spectrum yields information about spontaneous gamma emission from the target which could be used to determine the identity of radioactive material in the target. Secondly, any spontaneous emission may interfere with a photofission ratio determination (described later herein), so subtracting the ‘passive’ spectrum from the ‘photofission’ spectrum may be useful before calculating the ratio. Otherwise the system might be ‘spoofed’ by including highly radioactive material around a fissionable target.

Neutron-induced delayed external gamma radiation 42 may enter the radiation detection system 32 through an aperture 64 and the neutron-induced delayed external gamma radiation 42 may be detected by the gamma radiation detector 50. Delayed fission neutrons 40 may also enter the radiation detection system 32 through the aperture 64. Furthermore, because lead is substantially transparent to neutrons (unless it is very thick), the lead shield 58 (and optional lead face plate 84 shown in FIG. 4) typically may not significantly obstruct the passage of neutrons from entering the radiation detection system 32 from any direction. Thus, many of the delayed fission neutrons 40 that strike the radiation detection system 32 may be captured by the neutron-to-gamma-ray-converter material 52 to produce delayed internal gamma radiation 54 that may be detected by the gamma radiation detector 50.

Of particular interest among different materials that capture neutrons are materials that include hydrogen (and hydrogen compounds) and materials that include boron (and boron compounds) or other materials like gadolinium. When hydrogen atoms capture a neutron, 2.2 MeV gamma radiation is emitted. When boron atoms capture a neutron, gamma radiation at an energy level of approximately 478 KeV is emitted. When gadolinium captures neutrons, gamma radiation at an energy level up to 5 to 7 MeV is emitted with reasonably high probability. To detect 478 KeV gamma radiation, the gamma radiation detector 50 is typically a bismuth germanate oxide (BGO) gamma ray detector with a full width at half maximum (FWHM) resolution of approximately 9-12% in the region 250 keV to 600 keV. Sufficient resolution is needed to find a neutron capture gamma ‘peak’ but the detector does not need an exact resolution. It is also important to note that the detection of a 478 KeV or 2.2 MeV or higher energy gamma ray may not involve precisely those energy levels being deposited in the detector.

Ratios of energies detected above and below an energy point have proven to be a powerful method of determining if fissile material is present. Such gamma-rays may deposit (or be observed to have deposited) somewhat lower or higher energy levels over a generally Gaussian distribution. The statistical variation in detected energy level occurs primarily because of energy loss out of the detector of the primary gamma-ray energy and because of statistical fluctuations in the electronic charge produced by the interactions of gamma rays with a detector material and/or because of variations introduced by the pulse-processing electronics and/or because of losses of energy in the passage of a gamma ray from its point of creation to the detector. Hence, references herein to a gamma radiation detector that is configured to detect (for example) 2.2 MeV gamma rays, refers to a detector configured to detect a 2.2 MeV peak energy level within a statistical variation.

To measure radiation the radiation detection system 32 typically includes a radiation analysis system 66 that is connected to the gamma radiation detector 50. The radiation analysis system 66 is typically configured to detect and measure gamma radiation at different energy levels, generally from 0.1 MeV up to about 8 MeV.

FIG. 4 is somewhat schematic cross section of an alternative configuration of a radiation detection system 80 having a different lead shield 82. The lead shield 82 includes a lead face plate 84 that is approximately 0.5 to 1.25 inches thick. Consequently, the gamma radiation detector 50 and the neutron-to-gamma-ray-converter material 52 are essentially enclosed in the lead shield 82, with the only unshielded aspects being the result of small gaps between the shielding elements. As previously indicated, neutrons, such as delayed fission neutrons 40, may easily penetrate small thicknesses of lead (although some of their energy may be lost) and hence the delayed fission neutrons 40 are not significantly impaired by the lead shield 58 in reaching the neutron-to-gamma-ray-converter material 52. However, the prompt gamma radiation 34 and the neutron-induced delayed external gamma radiation 42 may be substantially shielded from reaching the gamma radiation detector 50 by the cylindrical section 56, the aperture panels 60 and 62, and the face plate 84. Systems for interrogating an examination article for the presence of nuclear material that are operating in the presence of high levels of ambient (background) gamma radiation may benefit from use of a lead shield such as the lead shield 82 that substantially surrounds the gamma radiation detector 50. When using a plastic scintillator detector as the gamma radiation detector 50, frontal lead shielding such as lead face plate 84 may be useful for enhancing detection of gamma radiation (particularly low-energy gamma radiation) emitted by neutron capture, such as delayed internal gamma radiation 54. In some embodiments a combination of at least one radiation detection system 32 (of the type depicted in FIG. 3) and at least one radiation detection system 80 (of the type depicted in FIG. 4) may be combined in a system for interrogating an examination article for the presence of nuclear material.

FIG. 5 is a perspective illustration of a radiation detection system 32 as depicted in FIG. 3. An aperture 64 in the lead shield 58 provides access for external gamma radiation (e.g., neutron-induced delayed external gamma radiation 42 of FIGS. 1, 2, and 3) to enter the radiation detection system 32.

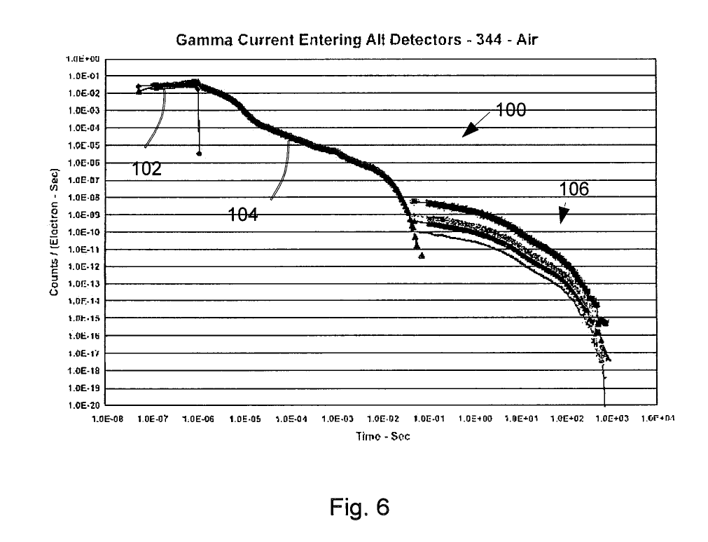

FIG. 6 is a plot 100 of detected gamma radiation predicted by a computer model of the system 10 of FIG. 2 for interrogating an examination article for the presence of nuclear material, using the radiation detection system similar to radiation detection system 32 with the radiation analysis system 66 depicted in FIG. 3. The plot 100 is based on a configuration where fissile material (for example a uranium block) is surrounded by air and the examination article is enclosed in a concrete room. Gamma-rays which enter the detector therefore can come from the fissile material (uranium block) and from neutron interactions with the nuclei in the concrete. However, the dominate gamma-ray field is from the uranium block.

Since the external gamma radiation is minimized, the plot 100 is also representative of detected gamma radiation predicted by a computer model based on the radiation detection system 80 with the radiation analysis system 66 depicted in FIG. 4. (That is, the presence or absence of the lead face plate 84 is irrelevant because the model assumes that there is no neutron-induced delayed external gamma radiation 42 emitted). The plot 100 shows the prompt (<than about 0.01 sec) and delayed gamma rays (>than about 0.01 sec) entering the detector where the gamma rays have an energy above approximately 0.1 MeV. In one embodiment a delay of 0.015 seconds provided the best analysis; it is generally beneficial to adjust the amount of delay depending on the test environment. Various components of the prompt and delayed gamma rays are also shown. The data are in histogram form and only the midpoints of the histograms are plotted. Also, the first data points for both the prompt and delayed gamma rays actually start at time equal 0, but are not depicted in this plot.

As illustrated in FIG. 6, starting less than 1 microsecond after the fissile material is exposed to photofission energy a burst of prompt gamma radiation 102 is detected. This is followed by a prompt neutron-induced gamma ray signal 104 that lasts until about one tenth of a second after the photofission energy burst. The delayed neutrons and gamma-rays start to emerge at time zero on the horizontal axis of plot 100. The delayed gamma-rays will be seen within an extremely short period of time after they are emitted since they are close to the detectors and travel at light speed. The delayed neutrons interact with the uranium block, the concrete in the walls, and the materials in the detector to produce additional gamma-rays. As can be seen in the plot 100, delayed gamma-rays are seen out to times of hundreds of seconds.

The following description assumes the system is operating at 15 Hertz. Other operating rates are also applicable. As previously indicated, the 15 MeV electron beam 22 (FIG. 2) is typically configured to impact the tungsten target 24 with pulses of electrons approximately 50 nanoseconds in duration. Each pulse produces a substantially concurrent burst of the gamma radiation beam 26 at energies up to 15 MeV. Following each pulse there is typically a dead time, typically ranging from approximately 15 msec to approximately 20 msec in duration to allow the prompt neutrons and gamma rays to dissipate before turning on the radiation detector systems 32. The radiation detector systems 32 are then turned on for approximately 45 ms to count delayed neutrons and gamma rays. This approximately 65 msec cycle time equates to an approximately 15 Hz pulse frequency. The detection of the pattern 106 (FIG. 6) of delayed gamma rays and neutron-induced gamma rays 106 is a preferred indication of the presence of fissile material in an examination article.

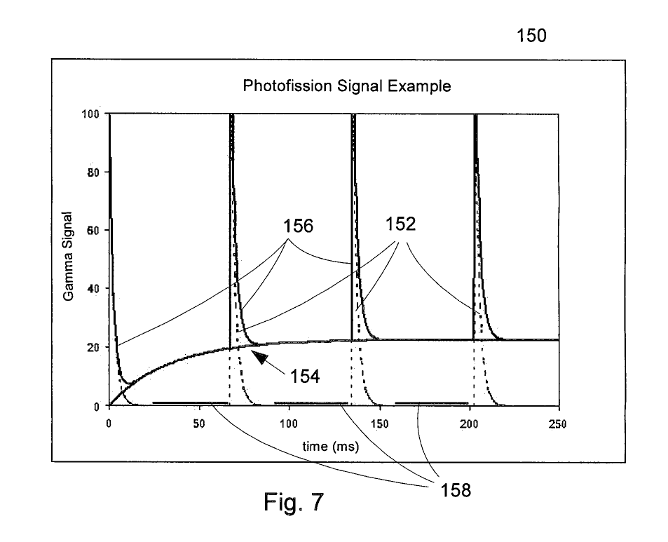

FIG. 7 illustrates a typical timing plot 150 for one embodiment of a photofission system. The dashed traces 152 represent ‘prompt’ gamma emission which occurs during a short time after the period when the accelerator-generated high energy beam is striking the target (and emission from other material in the beam path as well). The smooth solid trace 154 represents the buildup of ‘delayed’ fission products from fissionable target material—whose decay time constants are ‘much’ longer than the period between accelerator pulses; this component builds up over time to an equilibrium value as the accelerator operates. Secondary fissions also contribute here. The spiked traces 156 show the observed gamma emission from fissionable targets—the sum of prompt and delayed components. (Observed gamma emission from non-fissionable targets would decrease to zero when the prompt emission had decayed—the dashed traces 152 here). The bars 158 represent time intervals in which data were collected for use in the photofission ratio and neutron capture peak calculations. Typically data from multiple intervals are summed until a sufficient statistical precision is acquired. It should be noted that neutron emissions also follow the general pattern of FIG. 7 as well, with secondary effects due to more induced fissions and scattering. In some situations this may be an oversimplification but generally it suffices well enough to collect neutron capture peak data.

Typically multiple pulses are used to interrogate an examination article for the presence of fissile or fissionable nuclear material. Each pulse of photofission energy may generate a plurality of fission products and produce a plurality of fission neutrons. A portion of the fission neutrons may be captured by neutron capturing material that is either disposed proximal to the fissile material or that is disposed around a gamma radiation detector as neutron-to-gamma-ray-converter material. The capture process causes gamma radiation to be emitted. When hydrogen atoms capture a neutron, 2.2 MeV gamma radiation is emitted. When boron atoms capture a neutron gamma radiation at an energy level of approximately 478 KeV is emitted. Thus each pulse of photofission energy typically induces the emission of gamma radiation of energy greater than 0.1 MeV. The pulse rates, the number of pulses, and durations are chosen depending upon such factors as (a) the number of interrogating fission photons needed to produce a detectable signal and (b) the capabilities of the accelerator (e.g., 20 in FIG. 2). Often the pulses may continue for several minutes with the radiation analysis system 66 summing the pulse counts during selected time windows over the duration of interrogation. Typically the interrogation pulses are repeated over a total test time of about 1000 seconds. The duration of the test time may be adjusted to a length of time that gives the best signal-to-noise results. The radiation analysis system 66 may include a gamma ray spectrometer configured to detect the 2.2 MeV and 478 KeV energy lines of the gammas from the delayed neutrons (which provides additional information about the detection environment), as well as to detect other gamma rays which result from the capture of the delayed neutrons. In addition, the radiation analysis system 66 may be configured to count at least a portion of the gamma rays that result from the tail end of the prompt neutron gamma ray signal 104 in order to discern further characteristics specific fissile material that may be detected.

Various radiation signatures may indicate the presence of fissile or fissionable material in an examination article. It has been found that that the delayed gamma signal from interrogation of a fissile or fissionable target decreases less over time (or in other words remains high longer) than the delayed gamma signal from inert targets. This change is more pronounced at higher energies than lower energies. This observation provides a particularly useful signature ratio for identifying fissile or fissionable material. One example of such a signature is the ratio of (1) integrated delayed gammas (10 msec<t<65 msec) above 2 MeV to (2) integrated delayed gammas below 2 MeV. Ratios of energies detected in a first range that is above a first energy level and in a second range that is below a second energy level have proven to be a powerful method of determining if fissile or fissionable material is present. Note that in such evaluations the first energy level and the second energy level may be different energy levels or may be the same energy level. For example, a ratio comparing the integrated delayed gammas (10 msec<t<65 msec) above 2 MeV with the integrated delayed gammas below 2 MeV over the same time interval is an example of a ratio of energies detected above a first energy level and below a second energy level. Also, the integrated delayed gammas (10 msec<t<65 msec) above 2 MeV is an example of a “range” of delayed external gamma radiation of energy and the integrated delayed gammas below 2 MeV is a further example of a “range” of delayed external gamma radiation energy. The term “range” refers to a range of radiation energies.

Experiments with depleted uranium (which is substantially all ²³⁸U except for a trace amount of fissile ²³⁵U) have been used to develop a more optimal signature, as enumerated in Equation 1.

$$Photofission signature ratio = \frac{{\sum }_{time = 25 ms}^{67 ms} {\sum }_{energy = 3502 keV}^{8190 keV} {C}_{time , energy}}{{\sum }_{time = 25 ms}^{67 ms} {\sum }_{energy = 2 keV}^{900 keV} {C}_{time , energy}} \qquad {Eq}^{′} n 1$$

where C_{time, energy} is the contents of an accumulated two-dimensional histogram “scatter plot” of counts vs. time and energy. Equation 1 calculates a ratio of comparatively high-energy delayed gammas to comparatively low-energy delayed gammas with an intermediate energy range (902 to 3500 keV) being specifically absent from the calculation. The actual alarm threshold is best set by identifying a statistically significant excursion (rise in the observed ratio) compared with a running baseline of readings from interrogation of known inert samples. Also, it is possible that a target with significant radioactivity might cause systematic errors. Since there is little natural radioactivity with gamma emission above 2614 keV, errors would reduce the likelihood of detecting fissionable materials. In this case, the target-generated ‘background’ radiation could be subtracted from the regions of interest sums (2 KeV-900 KeV and 3502 keV-8190 keV) prior to computing the ratio. A photofission signature ratio that exceeds an alarm threshold is an example of a signature that is indicative of the presence of fissile or fissionable material in the examination article.

A further example of a signature that may indicate the presence of fissile or fissionable material is the presence of a boron or gadolinium neutron capture peak net area. For example, delayed neutron signals from 475 keV neutron capture gamma radiation produced when neutrons interact with ¹⁰B in the polyethylene rings surrounding BGO scintillators may be measured by summing two dimensional counts vs. energy vs. time data over the time region 25 ms to 67 ms after the accelerator pulse to form spectra. These spectra may be analyzed to compute the neutron capture peak net area, and the capture photopeak net area may examined for use as a signature of fissionable material. An alarm threshold may set by identifying a statistically significant excursion (a rise in the integrated counts per second around the 475 keV peak) compared with a running baseline of readings from interrogation of known inert samples. A neutron capture peak net area that exceeds an alarm threshold is an example of a signature that is indicative of the presence of fissile or fissionable material in the examination article.

A combination of complementary signatures may be used to assess the presence of fissile or fissionable material. For example, if fissile or fissionable material is shielded by lead, any delayed gammas may not escape the shield. However, delayed neutrons may escape and be captured by neutron-to-gamma-ray-converter material in the detector system and the resultant gamma rays may be detected and characterized as representing fissile or fissionable material using the second signature (boron or gadolinium capture net photopeak area) described in the above paragraphs. If fissile or fissionable material is shielded by water, delayed neutrons may be captured by the water but the resulting gamma rays may be detected and characterized as representing fissile or fissionable material using the first signature (ratio technique) described previously herein.

The operation of a system for interrogating an examination article for the presence of nuclear material typically includes a process that begins with a step of irradiating the examination article with energy that is sufficient to induce fission of at least a portion of a fissile or fissionable material present in the examination article. In preferred embodiments photofission energy is used to induce fission. If fissile or fissionable material is present, fission products are generated and at least one of the fission products produces fission neutrons. If a hydrogen-bearing neutron capturing material is disposed proximal to the fission product, external gamma radiation of energy greater than 0.1 MeV may be emitted when up to all of the fission neutrons are captured by at least a portion of the hydrogen-bearing neutron capturing material that is proximal to the fission product. In such circumstances the process continues by counting up to all external gamma radiation of energy greater than 0.1 MeV that is emitted when up to all of the fission neutrons are captured by the hydrogen-bearing neutron capturing material proximal to the fission product, if any fission neutrons are so-captured.

If any fission neutrons are not captured by the hydrogen-bearing neutron capturing material proximal to the fission products, the process typically continues with a step of capturing at least a portion of the fission neutrons that are not captured by the hydrogen-bearing neutron capturing material proximal to the fission product. If internal gamma radiation of energy greater than 0.1 MeV is emitted in this step, the process continues by counting up to all internal gamma radiation of energy greater than 0.1 MeV. The process then concludes with evaluating whether a combined count of the external and the internal gamma radiation exceeds a threshold indicative of the presence of fissile or fissionable material in the examination article. In some variations of the process only internal and external gamma radiation of energy greater than 0.1 MeV resulting from the capture of delayed fission neutrons is counted.

### EXAMPLE

In order to evaluate various aspects of photo-fission detection of materials, experiments were conducted using a linear accelerator (LINAC) at the U.S. Department of Energy's Idaho Accelerator Center. A (maximum) bremstrallung energy of 15 MeV was selected for photofission. This energy is near the maximum cross section for uranium fission and also below the fission threshold for most inert materials. The LINAC produces photons starting at ‘low’ energies up to a sharp cutoff at 15 MeV. The LINAC energy was not increased in order to avoid causing fission in various inert materials.

LINAC photo-fission energy was utilized to interrogate five test specimens: depleted uranium, steel, lead, beryllium, and “void” (no target in the beam path). Depleted uranium (which is substantially all ²³⁸U but contains approximately 0.2% ²³⁵U) was used as a surrogate for a more enriched sample of ²³⁵U, which was not available. Examination of the fission cross sections for ²³¹U, ²³⁵U, and ²³⁹Pu indicated that depleted uranium was a satisfactory surrogate. The depleted uranium target size was 12.1 cm×6.83 cm×5.72 cm, with a mass of 8.99 kg. Two steel targets were used: the first was made from paired 2.5 cm thick×10 cm×12 cm plates; the second was a solid block 5 cm×15 cm×10 cm. The beryllium target was a cylinder approximately 5 cm diameter×20 cm high. The lead target was a ‘standard brick’ (5 cm×10 cm×20 cm (2″×4″×8″).

Each of these samples was surrounded by ‘typical’ matrix materials that might be expected to be found in shipping containers: air, wood, water, and lead. Water and lead were included to evaluate their potential effects if used in an attempt to cloak the presence of fissile or fissionable material.
Water: ‘Small’ matrix: 61 cm×61 cm×91 cm high (2′×2′×3′) and ‘large’ matrix: 123 cm×123 cm×91 cm high (4′×4′×3′) water tanks were used. Water may be considered a surrogate for diesel fuel and similar liquids. Detection of fissionable material surrounded by a moderator had often been difficult for systems based on delayed neutron measurements. Targets were suspended in a dry well within the water tanks.
Lead: Lead enclosures were built from lead bricks, each approximately 40 cm×40 cm×30.5 cm high (16″×16″×12″), with different wall thickness: 2.5 cm, 5 cm, or 7.6 cm. These enclosures were left open at the top and bottom for access to the targets. Lead represented a potential challenge for systems based on delayed gamma detection. The largest lead enclosure—10 cm thick walls—was estimated to weigh 1250 lbs.
Wood: Wood matrices were used with the target centered in an assembly of solid wood: ‘small’ matrix: 61 cm×61 cm×91 cm high (2′×2′×3′) and ‘large’ matrix: 123 cm×123 cm×91 cm high (4′×4′×3′). Wood matrices were built from dry pine boards, stacked in interlocking layers. Wood represented a typical low-density cargo material.
“Void:” Unshielded targets (‘Air’ matrix—no surrounding material)

BGO scintillators (3″ diameter×6″ long, purchased from Scionix) were used for gamma radiation detection. Using the BGO scintillators rather than plastic or NaI (Tl) detectors proved to be advantageous in detecting high energy gamma radiation. The BGO scintillators were surrounded by a layer of polyethylene containing 5% by weight natural boron dispersed in the polyethylene. Natural boron contains 15% ¹⁰B, which is used to convert incoming neutrons to gamma radiation. The polyethylene acts as a moderator to moderate the neutron energies, increasing the likelihood that they will be captured by the ¹⁰B. The polyethylene blanket and detector is encased in a 1″ thick lead shield to reduce the intensity of low energy gamma radiation reaching the detectors. The lead is useful in reducing the background radiation due to construction materials used in building the experimental cell in which the proof of concept experiments were carried out. These detectors were substantially as depicted in FIG. 5 herein. A total of six 3″ diameter×6″ long BGO detectors—were used. The six gamma detectors were calibrated prior to shipment to Idaho and once per day (morning) before starting experiments. A calibration using a Cf-252 neutron source was done prior to shipment, using a point source 24″ (61 cm) from the three modules in a configuration identical to the target placement used for photofission.

The detector module contained a ‘window’ (described as aperture 64 herein) in the lead shield which was included to avoid attenuation of the delayed fission gamma rays. During the experiments it was believed that covering the ‘window’ with 1″ thick lead plates would reduce detected gamma radiation from natural background, improving the signal-to-noise ratio for detecting gamma radiation from photofission. The shielded version is depicted in FIG. 4 herein. It was later found that the 1″ thick lead shields surrounding the detectors and lead collimator did not reduce background radiation sufficiently and that the shield geometry was probably not effective in limiting the detector's view, especially when high energy gamma rays (>2 MeV) were present. The shield thickness may need to be increased substantially to be effective in limiting the detector's view. Since the detector operates in a dual mode of gamma and neutron detection, additional shielding would absorb neutrons as well. Such shield geometry would likely be effective for preliminary passive scanning prior to active interrogation in a commercial scanning instrument.

Photomultiplier outputs from the BGO detectors were processed by preamplifiers (ORTEC 296), fast amplifiers (ORTEC 579), and digitized into spectra by fast analog-to-digital converters (ADC, FastComtec 7072). Histogram data were collected and stored as counts vs. energy×time—a two dimensional histogram—using a FastComtec SPA-3 multichannel analyzer. The analyzer was modified by the manufacturer (Real Time Clock option) to record gamma data vs. time after the LINAC pulse. Fast Comtec's MPA-3 software was used to operate the MCA. A standard PC recorded and displayed the data using FastComtec's MPA-3 software application. Amplifier time constants were set to minimum values to allow as fast counting as possible. This resulted in poorer spectral resolution (˜12% for individual detectors) which was accepted to achieve faster counting rates.

Experimental timing was based on model results with empirical optimization. The LINAC was operated in pulsed mode, with a 15 Hz repetition rate. Pulse widths were 50 ns and the charge output per pulse varied from 70 to 120 nCoulombs per pulse. (100 nCoulombs per pulse was the target charge but the LINAC could not achieve this level consistently). Data were acquired after a delay following the accelerator pulse because only delayed emission after the accelerator pulse was characteristic of fissionable material.

The instrumentation accumulated gamma spectral results in a two-dimensional array of counts vs. time after the accelerator pulse and energy. Ranges were 0-67 ms for the time range and 0-8 MeV for the energy range. Data were added to this two-dimensional histogram over multiple 67 ms intervals until the multichannel analyzer reached a live time preset, usually 1000-4000 s. ‘Start’ time pulses were provided to the instrumentation from the accelerator control system to synchronize the time histogram with the LINAC operation.

Data analysis involved selecting regions of the original histogram and producing energy and/or time spectra. Gamma time-dependent data were accumulated both as gross count rate vs. time and rates over several energy ranges vs. time. Neutron emission time-dependent data were accumulated by detecting the 475 keV capture gamma from the ¹⁰B (n,α)⁷Li reaction, generating a photopeak in the recorded gamma spectrum.

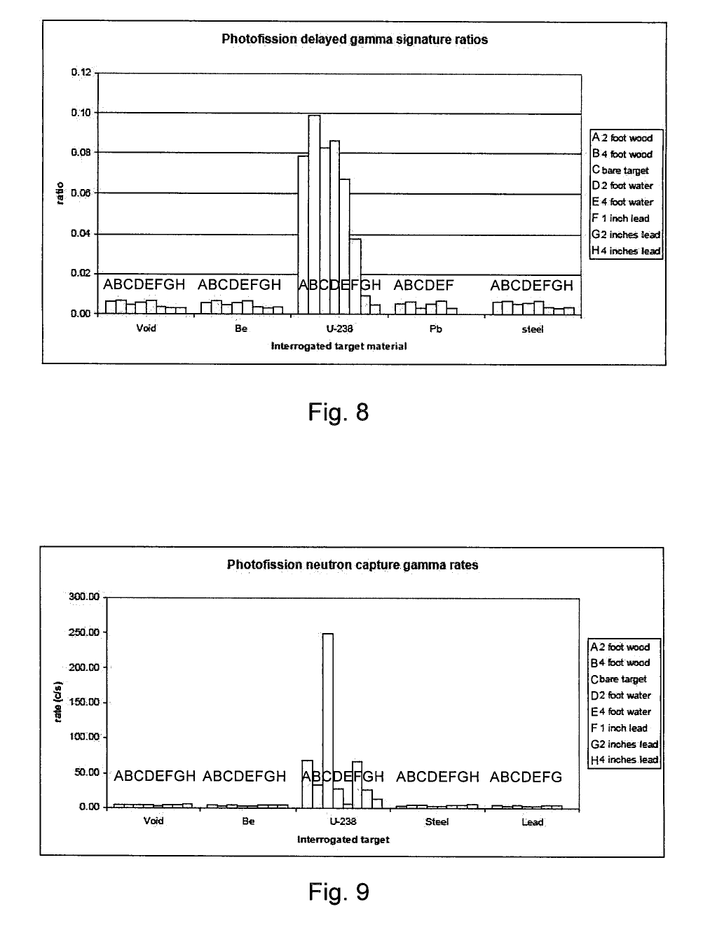

Photofission signature ratios (per Equation 1) were calculated for various target materials each surrounded by various matrix materials. The results are summarized in FIG. 8. The ratios for the fissionable target (depleted uranium-labeled U-238 in FIG. 2) is an order of magnitude greater than the ratios for the inert materials for all shielding matrices except the lead enclosures. Even with the 1″ thick lead enclosure the ratio is about a factor of five higher than the ratios established by the inert materials. Detection of the fissionable target in 5 cm (2″) thick lead is likely possible. Only in the case where the depleted uranium is surrounded by 10 cm (4″ thick) lead is the photofission signature ratio unlikely to detect the fissile or fissionable material. The ratio method successfully detected the fissionable target in the large water tank, which corresponds to a potential smuggling scenario in which fissile or fissionable material is carried in a water or fuel truck.

Several potential enhancements to the ratio calculation were examined. In one variation the counts in each histogram bin were weighted by energy. In another variation a possible use of the middle ROI (902 keV to 3500 keV) was evaluated as an indicator of scattering or natural emission. No significant advantage in terms of better discrimination between fissionable and inert targets was found that would offset the added complexity resulting from inclusion of such additional factors.

Next, the delayed neutron signal, measured using the 475 keV neutron capture gamma produced when neutrons interact with ¹⁰B in the polyethylene rings surrounding the BGO scintillators, was evaluated as a second type of fissionable material signature. Two dimensional counts vs. energy vs. time data were summed over the time region 25 ms to 67 ms after the accelerator pulse to form spectra. These spectra were analyzed to compute the neutron capture peak net area. The capture photopeak net area was examined for use as a signature of fissionable material. Large differences were identified in the delayed emission neutron capture peak areas for fissionable and inert targets, as illustrated in FIG. 9. The differences in the neutron capture peak net area clearly indicated the presence of the fissionable depleted uranium target in all matrices except the 4′×4′×3′ water matrix. Good differentiation between fissionable and inert targets can be seen for the lead enclosures, including the 4″ thick enclosure, where the photofission signature ratio was less successful.

The detection of small amounts of neutron capturing in inert targets may be due to delayed emissions attributable to natural thorium in fill materials used to build the facility where the tests were conducted. Consequently, net photopeak count rates for inert targets may be lower in systems deployed in ‘open’ surroundings. Another phenomenon that is thought to be facility related was the presence of a gamma photopeak in the IAC background spectrum, which interfered with the neutron capture photopeak. The interfering peak area was smaller than the neutron capture photopeak, so it did not interfere with ‘bare target’ measurements. However, for measurements in which most of the neutron emission was absorbed, such as the water matrices, this interference required fitting overlapping photopeaks to correctly obtain the neutron capture photopeak area. The combined interference and gain shift makes automated photopeak fitting difficult. Neutron capture photopeak areas were calculated by fitting Gaussians with local linear baselines to all data. Generally, a neutron capture photopeak and interfering photopeak were fit to the data. Fits were calculated both by the FastComtec ‘MPA-3’ software and by observation ‘manual fit.’ Better results were obtained using manual fitting for spectra that contained interfering photopeaks. Consequently the photopeak fitting was done manually for the data presented here.

The combination of the two signatures (the ratio method and the neutron capture peak net area) was found to correctly differentiate between a fissionable target and inert targets (lead, steel, air, and Beryllium), with substantial differences in delayed gamma and/or neutron signatures for fissionable and inert materials in all cases. The signatures are simple to compute and are not significantly affected by system variations or interferences expected during cargo scanning.

In summary, embodiments disclosed herein provide a system and method for interrogating an examination article for the presence of nuclear material. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A radiation detection system comprising:
a gamma radiation detector;
a neutron-to-gamma-ray-converter material surrounding at least a portion of the gamma radiation detector;
a lead shield surrounding a substantial portion of the neutron-to-gamma-ray-converter material and surrounding at least a portion of the gamma radiation detector.

2. The radiation detection system of claim 1 wherein the neutron-to-gamma-ray-converter material comprises a moderator material.

3. The radiation detection system of claim 1 wherein the neutron-to-gamma-ray-converter material comprises boron and polyethylene.

4. The radiation detection system of claim 1 wherein the neutron-to-gamma-ray-converter material and the gamma radiation detector are essentially surrounded by the lead shield.

5. A system for interrogating an examination article for the presence of a fissionable material, comprising:
a photo-fission energy beam source configured to irradiate the examination article and trigger fission of the fissionable material, wherein delayed fission neutrons are generated; and
a detector system comprising (a) a neutron-to-gamma-ray-converter material configured to capture up to all of the delayed fission neutrons and upon capture to emit delayed internal gamma radiation, and (b) a gamma radiation detector configured to detect at least a portion of the delayed internal gamma radiation.

6. The system of claim 5 further comprising a radiation analysis system configured to evaluate whether a count of the delayed internal gamma radiation represents a signature that is indicative of the presence of fissionable material in the examination article.

7. The system of claim 5 further comprising a radiation analysis system configured to evaluate whether a count of the delayed internal gamma radiation indicates the presence of a neutron capture peak net area.

8. The system of claim 5 wherein the photo-fission energy beam source is further configured to generate delayed external gamma radiation when the fission of the fissionable material is triggered, and wherein the gamma radiation detector is further configured to detect the delayed external gamma radiation.

9. The system of claim 5 wherein the photo-fission energy beam source is further configured to generate delayed external gamma radiation when the examination article is irradiated and the fission of the fissionable material is triggered, and wherein the gamma radiation detector is further configured to detect the delayed external gamma radiation, and wherein the system further comprises a radiation analysis system configured to evaluate whether a combination of (1) a first count of the delayed external gamma radiation and the delayed internal gamma radiation in a first energy range, and (2) a second count of the delayed external gamma radiation and the delayed internal gamma radiation in a second energy range represents a signature that is indicative of the presence of fissionable material in the examination article.

10. The system of claim 5 wherein the photo-fission energy beam source is further configured to generate delayed external gamma radiation when the examination article is irradiated and the fission of the fissionable material is triggered, and wherein the gamma radiation detector is further configured to detect the delayed external gamma radiation, and wherein the system further comprises a radiation analysis system configured to evaluate whether a ratio of (1) a first count of the delayed external gamma radiation and the delayed internal gamma radiation in a first energy range above approximately 3502 keV and (2) a second count of the delayed external gamma radiation and the delayed internal gamma radiation in a second energy range below approximately 900 keV represents a signature that is indicative of the presence of fissionable material in the examination article.

11. The system of claim 5 wherein the photo-fission energy beam source is further configured to generate delayed external gamma radiation when the fission of the fissionable material is triggered, and wherein the detector system comprises a plurality of gamma ray detectors and gamma-radiation shielding material configured to prevent substantially all external gamma radiation having energy less than a threshold level from reaching at least a portion of the plurality of gamma ray detectors.

12. A method of detecting the presence of a fissionable material in an examination article comprising:
(a) irradiating the examination article with energy sufficient to induce fission of at least a portion of the fissionable material present in the examination article, wherein external delayed gamma radiation and delayed fission neutrons are produced;
(b) capturing in a neutron-to-gamma-ray-converter material at least a portion of the delayed fission neutrons wherein delayed internal gamma radiation is generated;
(c) compiling a first delayed gamma radiation count in a first energy range over a time window;
(d) compiling a second delayed gamma radiation count in a second energy range over the time window;
(e) evaluating whether the first gamma radiation count and the second gamma radiation count together are indicative of the presence of fissionable material in the examination article.

13. The method of claim 11 further comprising compiling a count of internal gamma radiation representative of a neutron capture peak net area and evaluating whether the count of internal gamma radiation representative of the neutron capture peak net area is indicative of the presence of fissionable material in the examination article.
